(19) United States
(12) Patent Application Publication
(10) Pub. No.: US 2004/0221459 A1
(43) Pub. Date: Nov. 11, 2004

(54) Spaghetti spoon

(76) Inventor: Rolland Wayne Rich, Albany, GA (US)

Correspondence Address: BRIAN D. BELLAMY, P.O. BOX 1997, THOMASVILLE, GA, 31799-1997, US

(21) Appl. No.: 10/435,470

(22) Filed: May 8, 2003

(51) Int. Cl. A47J 43/28

(52) U.S. Cl. 30/324

(57) ABSTRACT

A tool is provided for eating strands of food with the function of cutting and a spoon. The tool includes body members having tool portions that form a spoon shaped bowl portion of diverging halves that are separable into an open scissor configuration. The body members are pivotally connected at their central portions, and terminate in handle portions. A first handle portion is angled upwardly from the spoon shaped bowl portion to function ergonomically as a handle of a spoon. A second handle portion includes a ring member oriented downward from the first handle portion, such that the first handle portion and the second handle portion are not in the same horizontal plane. The ring member is oriented outward at an angle of about 30 degrees with respect to a vertical plane through the spoon shaped bowl portion.

### BACKGROUND OF THE INVENTION

1. Field of the Invention

The present invention relates to utensils for eating food. More particularly, the invention pertains to a spoon for eating strands of food such as spaghetti. The novel spaghetti spoon provides a scissor configuration for cutting and sizing a portion of spaghetti and provides ergonomically oriented controls for cutting and using the spoon conveniently.

2. Description of the Prior Art

Eating strands of food, such as spaghetti, has long been a challenge. While stranded foods are often very appetizing, consuming these foods can often be embarrassing. For instance, a job applicant attending a meal and job interview at an Italian restaurant may very well order spaghetti as a tasteful and inexpensive meal. However, the nice shirt and tie being worn by the interviewee may become embarrassingly stained by drippings of tomato sauce and noodles by the end of the meal, or the interviewee may not have contemplated the slurping and sucking of noodles that would be required to consume the difficult to manage noodles. Thus, a need exists to be able to eat strands of food or spaghetti in a more dignified manner.

It has been recognized by those who consume foods such as spaghetti that to eat in a dignified manner one must regulate the size of the mouthful of spaghetti fed. Further, loose ends must be minimized or eliminated to avoid slurping and sucking those loose ends into the mouth. Before now, a person would hold a spoon against a fork full of spaghetti and twist and lift until a ball of spaghetti was wound around the fork, then place the ball of spaghetti into the mouth. However, long pieces inevitably would remain hanging from the fork, resulting in the persistent need to slurp or suck the long pieces into the mouth. Also, using a fork has continued to lead the average eater to often drip or sling sauce onto clothing or onto the face and around the mouth.

Very few legitimate solutions have been provided to avoid these embarrassing and undignified moments.

U.S. Pat. No. 4,521,964 to Maruyama teaches a tool for meals with the function of scissors. In Maruyama a system of scissors is formed. The spoon embodiment has the function of scissors with two blade bodies. Each blade body has the shape of one part in which the sunken portion of the tip of a usual spoon for meals is divided in two portions. Each blade body consists of the tip portion in which an edge is set in the divided border side, the central portion and the handle portion. Two blade bodies form scissors combined by a pin at the axis of the scissors in each central portion of the two blade bodies. As each edge of the two-blade bodies overlaps the other, the tip portion is similar to the sunken portion of a usual spoon for meals.

As illustrated in FIGS. 16, 17, 19, 20, 21, 23, and 24, of Maruyama, the U.S. Pat. No. 4,521,964 shows a standard scissor configuration with scissor handles in a single plane. Maruyama does not teach or provide a regular spoon handle for easy and ergonomically correct handling. Instead, Maruyama provides a pair of ring members in a single plan that are much more cumbersome to handle than a typical spoon. Further, the scissor handles in Maruyama are not specially configured for handling in an ergonomically correct manner when eating food. Instead the scissor handles are configured identically to typical scissors for cutting paper or the like. The Maruyama design appears that it would require a person to handle the tool in an uncustomary manner when eating food.

U.S. Pat. No. 3,939,562 to Pellerin teaches utensils for eating strands of foods. Pellerin provides for a spoon-type utensil having means for cutting strands of food. The cutting means is formed by two edges defining a tapering slot in which strands are cut. One edge of the slot is the rim of the bowl of the utensil. The other edge is provided by a diverging portion of a member overlying a portion of the bowl.

The Pellerin reference, U.S. Pat. No. 3,939,562, does not provide a scissor mechanism for cutting strands, rather a slot is provided at least partly around the bowl of the utensil, with at least one of the edges of the slot being a cutting edge, whereby the strands of food while penetrating into the tapering slot are gradually applied against the cutting edge to be cut. The Pellerin design appears to work best when a second fork-like utensil is also provided specifically adapted for use with the spoon-type utensil. Handling the two utensils in a solitary manner would appear to require skill and be more difficult than a single utensil would be.

Therefore, a need clearly exists for single utensil for eating stranded food that is ergonomically convenient, provides the function and ease of use of a regular spoon in a customary manner, does not require extra utensils, and provides for trimming and sizing a serving of stranded food for eating a correct portion without messy ends hanging from the utensil and causing dripping, dropping, or slurping of food.

### SUMMARY OF THE INVENTION

The present invention is a tool for eating strands of food with the function of cutting and a spoon. The invention may be referred to as a spaghetti spoon because it is very useful for eating spaghetti but could be used for eating any food that is conducive to the lifting and sizing of portions using the tool provided. The advantages of the present invention are that a single utensil is provided for effective function and that the utensil is ergonomically easy to use, and, therefore, especially convenient.

The spaghetti spoon provided includes first and second body members pivotally connected to one another near the central portions thereof. Whereby, the body members are crosswise like the members of a pair of scissors and connected at a pivot point. The pivot point could be a screw or rivet or pin or the like.

The first and second body members have respective first and second tool portions and respective first and second handle portions. The first and second tool portions form the bowl or head of a spoon, but split into halves. Each first and second tool portion has the shape of one part of the sunken portion of the tip of a usual spoon for meals. The first and second tool portions align and abut together at inner edges of the tool portions' abutting sides to form a spoon shaped concave bowl portion. The tool portions are separable to permit separation of said first and second tool portions into a diverging configuration in which food may hang for cutting.

An inner edge is set in each abutting side of the tool portions. At least one of the tool portions may have serrations formed within the inner edge surface for securely gripping and cutting strands of food. At least one inner edge of the tool portion may be sharpened for more efficient cutting action. For instance, the non-serrated edge opposing the serrated edge may be sharpened to cut the food as it is secured by the opposing serrated edge. Opening and separating the first and second tool portions, then closing creates a cutting action against the strands of food. The serrated or non-serrated edges are used to snip the spaghetti or other food and trim long pieces, leaving only a spoon full of food in the concave spoon portion of the tool.

Opposing the tool portions, the body members terminate in respective first and second handle portions to form a scissor like handle grip. The first handle portion is substantially a flat horizontal surface angled slightly upwardly to function ergonomically as a typical handle of a spoon. The second handle portion is formed substantially adjacent the pivot axis of the crosswise connected member and comprises an oval ring member. The ring member is situated such that it is oriented downward with respect to the first handle, and the ring member is oriented outward from a vertical plane intersecting the spoon shaped bowl portion. The angle separating the ring member from the vertical cross-section plane of the spoon portion is about 30 degrees. The 30-degree angle promotes the function of the spaghetti spoon as the handle of a scissor, while retaining the usefulness of the device as a spoon. The scissor-like handle grip is thumb or finger activated. The grips of the spoon-like handle and the scissor-like ring member together define a single manipulating handle to be grasped in one hand by the user.

The grip may be activated for cutting strands of food by simply moving a thumb or finger to manipulate the tool portions and make the cutting action. The user dips the end of the tool comprising the first and second tool portions into food and lifts while opening and closing the tool portions to cut strands that are hanging between the tool portions. The cutting action leaves a manageable ball of spaghetti in the spoon without the loose hanging ends normally associated with eating spaghetti. Thus, the spaghetti spoon allows a person to eat spaghetti of other desired food in a dignified manner with less mess and without slurping or sucking.

### BRIEF DESCRIPTION OF THE DRAWINGS

FIG. 1 is a top plan view of a spaghetti spoon constructed in accordance with the present invention.

FIG. 2 is a top plan view of the diverging tool portions of the spaghetti spoon in an open scissor configuration.

FIG. 3 is a side plan view of a spaghetti spoon constructed in accordance with the present invention.

FIG. 4 is a partial side view of a cross-section of the spaghetti spoon constructed in accordance with the present invention.

FIG. 4 is a sectional top plan view of the diverging tool portions of the spaghetti spoon in an open scissor configuration.

FIG. 5 is a front perspective view of the spaghetti spoon constructed in accordance with the present invention.

FIG. 6 is a front cross-sectional view of the tool portions of the spaghetti spoon in a closed scissor configuration.

FIG. 6A is an enlarged cross-sectional view of the inner edges of the tool portions of the spaghetti spoon in a closed scissor configuration.

### DETAILED DESCRIPTION OF THE PREFERRED EMBODIMENT

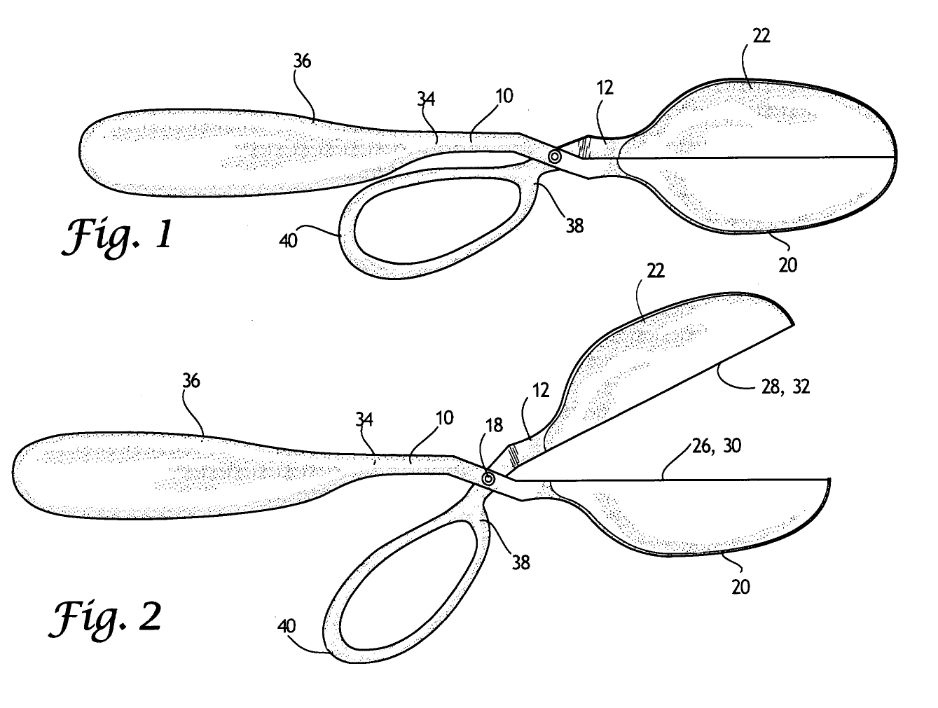

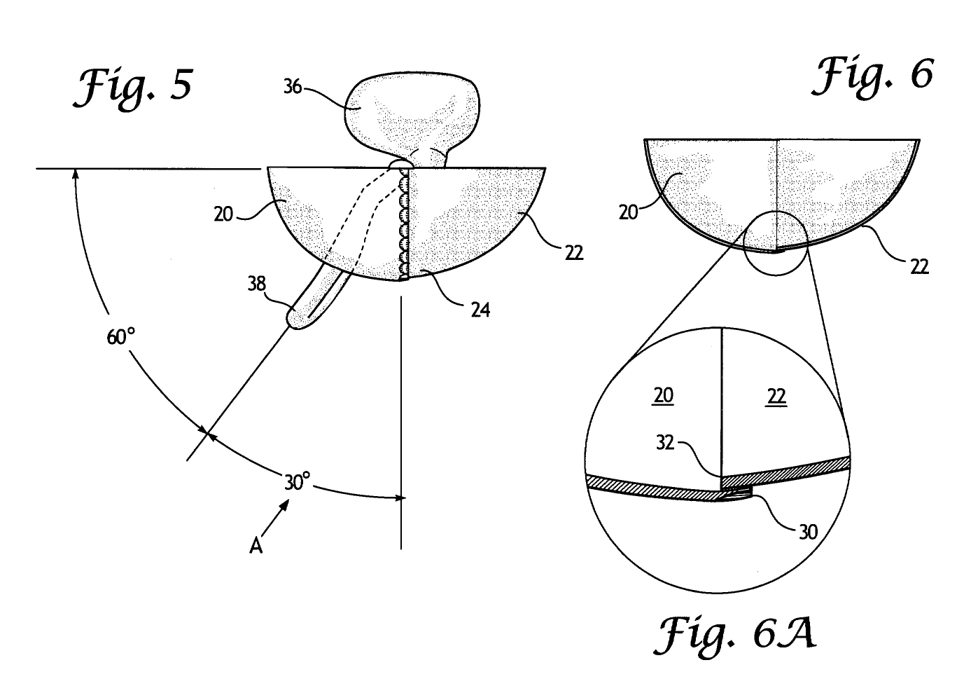

The present invention will be described in further detail with reference to the illustrated embodiment and by referring to FIGS. 1-6A.

FIG. 1 illustrates a spaghetti spoon or utensil made in accordance with the teachings of the present invention and depicts a preferred embodiment. The utensil includes three primary separate components, a first body member 10, a second body member 12, and a pivot point 18.

The first body member includes a central portion 14, and likewise the second body member includes a central portion 16. The first and second body members 10, 12 are pivotally connected to one another at the pivot point 18 near central portions 14 and 16 thereof by being situated crosswise and attached via a pin such as a screw, rivet, or any other suitable device for creating a central pivoting point for the two body members 10, 12. The crosswise central portions 14, 16 are configured or bent with respect to each other for proper and efficient operation of the utensil body members 10, 12.

The first and second body members each have a respective tool portion, referred to herein as the first tool portion 20 and second tool portion 22, respectively. The tool portions will form the tip of a spoon or a spoon portion 24. A dividing edge 26, 28 on each tool portion will generally abut where the tool portions are separated. The first and second tool portions each have the shape of one part of the sunken portion of the tip of a usual spoon for meals divided into two portions. Thus, the first tool portion 20 and second tool portion 22 align and, when abutting together, form the concave bowl of the spoon portion 24.

The separable dividing edges 26, 28 permit separation of the first and second tool portions 20, 22, allowing the tip of the spoon 24 formed by the tool portions to diverge and converge during operation. The divergence and convergence of the tool portions 20, 22 provides operation and formation of the scissor mechanism shown by the open scissor configuration of FIG. 2 and the closed scissor configuration illustrated in FIGS. 1, 5 and 6.

The inner dividing edges 26, 28 of the tool portions 20, 22 may be serrated or sharpened to improve the cutting action of the device. In one embodiment depicted in FIGS. 4, 5 and 6A, the dividing edge 26 on the first tool portion 20 is serrated 30 for improved gripping of food and efficiency in cutting. Further, the dividing edge 28 on the second tool portion 22 is sharpened 32.

The first and second body members 20, 22 each have a respective handle portion, referred to herein as the first handle portion 34 and second handle portion 38. The handle portions 34, 38 extend from the central portions 14, 16 of the body members and provide terminal ends of the body members from the opposing terminal ends provided by the tool portions 20, 22. The handle portions form a combined handle grip that is operable both like the grip of a spoon and like the grip of a pair of scissors.

The handle portions may be formed beginning substantially adjacent the pivot axis of the crosswise connected members at the central portions, and are preferably ergonomically configured for comfort and control. The grips together do not require two hands to manipulate, but define a single manipulating handle to be grasped in one hand by the user, whereby the grip may be activated for cutting strands of food by simply moving a thumb or finger to manipulate the tool portions and make the cutting action.

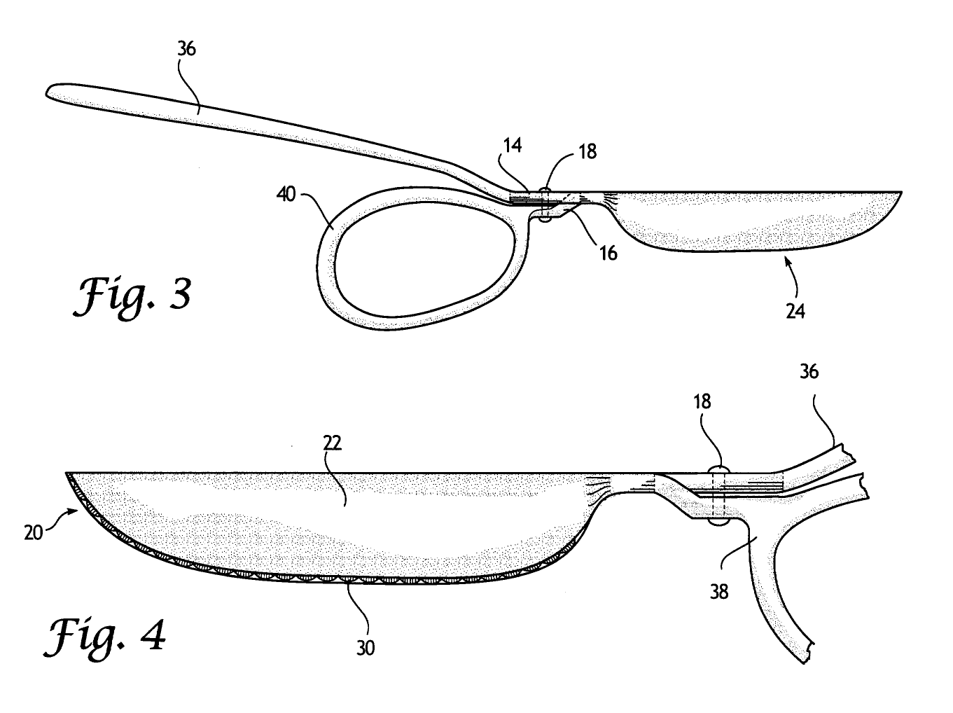

In particular, the first handle portion 34, which extends from the first central portion 14, provides a substantially flat upper surface 36 angled slightly upwardly from the central portion. The flat surface 36 of the first handle portion 34 functions ergonomically well, as a typical handle of a spoon. The shape of the first handle portion 34 may be varied, and even made curved or cylindrical in accordance with the varying ornamental tastes of consumers in utensils.

Whereas, the second handle portion 38 includes an oval ring member 40. The ring member 40 is situated and oriented downward with respect to the first handle portion 36, and the ring member is oriented at an outward angle from a figurative vertical plane intersecting the spoon shaped bowl portion 24. The outward angle at which the ring member 40 is oriented from the vertical is about 30 degrees (A) as shown in the embodiment of FIG. 3. The author of the invention has found the 30-degree angle (A) orientation of the ring member 40 to promote ease of use and to allow the ring member to function ergonomically as the handle of a scissor in combination with the first handle portion 34. The angle (A) may be adjusted according to preference and a range of values may be provided for the angle (A) of orientation of the ring member. Potential values may range from a few degrees from vertical to nearly horizontal. However, less advantage will be provided ergonomically speaking when this angle of orientation is adjusted too an extreme. Depending on the user's grip the ring member 40 may be thumb activated or finger activated according to preference.

In operation, the user dips the tip of the device comprising the first and second tool portions 20, 22 into food, such as spaghetti, and lifts while opening and closing the tool portions to cut strands of food hanging between the tool portions. After performing the operation of dipping and cutting, a manageable ball food, such as spaghetti or strands of other food, is left in the spoon without the loose hanging ends. The spaghetti spoon is especially useful for elimination the hanging strands of noodles normally associated with eating spaghetti. Therefore, using the present invention creates less mess and decreases that amount of undignified slurping or sucking required eating spaghetti.

While the present invention has been particularly shown and described with reference to an embodiment thereof shown in the figures, it will be understood by those skilled in the art that various changes in form and detail may be made without departing from the spirit and scope of the present invention.

I claim:

1. A tool for eating strands of food with the function of cutting and a spoon comprising:
a. first and second body members;
b. the first body member having a first tool portion, and the second body member having a second tool portion, and each tool portion adapted to align and coact to form a spoon shaped bowl portion and are separable to permit divergence of the first and second tool portions into an open scissor configuration;
c. a central portion of the first body member, said central portion being pivotally connected by a pin to a central portion of the second body member
d. a first handle portion of the first body member extending from the central portion of the first body member, and a second handle portion of the second body member extending from the central portion of the second body member;
e. the first handle portion being angled upwardly from the spoon shaped bowl portion to function ergonomically as a handle of a spoon;
f. the second handle portion including a ring member situated and oriented downward from the first handle portion, such that the first handle portion and the second handle portion are not in the same horizontal plane.

2. A tool for eating strands of food as in claim 1 in which the first and second tool portions each comprises one-half of the body of said spoon shaped concave bowl portion.

3. A tool for eating strands of food as in claim 1 in which the first tool portion and second tool portion each include a dividing edge for the divergence into the open scissor configuration and at least one of the dividing edges includes serrations.

4. A tool for eating strands of food as in claim 1 in which the ring member is situated and oriented downward from the first handle portion and oriented outward at an angle with respect to a vertical plane through the spoon shaped bowl portion.

5. A tool for eating strands of food as in claim 4 in which the angle with respect to the vertical plane is about 30 degrees.

6. A tool for eating strands of food as in claim 1 in which the first handle portion has a substantially flat upper surface.
